(19) United States
(12) Patent Application Publication
(10) Pub. No.: US 2007/0287469 A1
(43) Pub. Date: Dec. 13, 2007

(54) Spectrum utilization in a radio system

(75) Inventors: Carl Wijting, Helsinki (FI); Jean-Philippe Kermoal, Veikkola (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/790,620

(22) Filed: Apr. 26, 2007

(30) Foreign Application Priority Data
Apr. 26, 2006 (FI) 20065269

(51) Int. Cl. H04Q 7/20

(52) U.S. Cl. 455/454

(57) ABSTRACT

The invention relates to sharing a radio spectrum between a first radio system and a second radio system which co-exist so that the radio spectrum is shared at least locally. A radio access point of the first radio system is provided with information on the co-existing second radio system and the constraints it causes to user terminals operating in the service area of the radio access point. The radio access point may retrieve or obtain information about the other radio system by any appropriate, such from a centralized database. Based on the information the radio access point creates and broadcasts beacon or control information to user terminals operating in the service area of the radio access point, to thereby enable the user terminals to adjust their operation so that they can co-exist with the second radio system. Thus, there are two processes: information retrieval about another (second) system and signalling of the spectrum sharing information.

### FIELD OF THE INVENTION

The invention relates to sharing a radio spectrum between radio systems.

### BACKGROUND OF THE INVENTION

Future wireless services will be provided by many types of wireless systems using different radio access technologies. Within the WINNER—Wireless World Initiative New Radio—project a new air interface for a range of application scenarios is developed. To allow the seamless interaction of the new air interface it is important to support interworking with existing as well as future wireless systems. The WINNER project aims to develop radio interfaces covering different domains (local area, metropolitan area, and wide area) with the same radio interface. Key innovation areas within the project include, beside the use of larger bandwidths (which allow for high data rates), new concepts such as spectrum sharing and network relays. One key objective of the WINNER project is obtaining new radio spectrum for future radio systems. It is expected that spectrum sharing mechanisms will be important for operating in these new spectrum bands. Another key area of innovation is relaying. When using relaying, a relay is placed between the base station and the user terminal. The relay behaves as a scaled-down base station and can help in extending the coverage range, providing extra diversity etc.

### BRIEF DESCRIPTION [DISCLOSURE] OF THE INVENTION

An object of the present invention is to provide a method and a mechanism for providing efficient spectrum sharing in a wireless communication system.

The objects of the invention are achieved by a method, system, radio access point and a user terminal which are characterized by what is stated in the independent claims. The preferred embodiments of the invention are disclosed in the dependent claims.

There are two processes: information retrieval about the other (second) system and signalling of the spectrum sharing information. A first radio system co-exists with at a second radio system so that the radio spectrum is shared at least locally. A radio access point of the first radio system is provided with information on the co-existing second radio system and the constraints it causes to user terminals operating in the service area of the radio access point. The radio access point may retrieve or obtain information about the other radio system by any appropriate, such from a centralized database. Based on the information the radio access point creates and broadcasts beacon or control information to user terminals operating in the service area of the radio access point, to thereby enable the user terminals to adjust their operation so that they can co-exist with the second radio system.

According to an embodiment of the invention, The collected information about the second radio system can be stored in a database. This database can be used by the first radio system for spectrum sharing, e.g. signaling information can be retrieved from it, and decision can be based on the information that it contains. The database can contain the parameters that can be signaled, such as interference information, activity patterns, location information etc.

According to some embodiments of the invention, the broadcast beacon or control information may include one or more of following information elements: exclusion zone (e.g. a user terminal is not allowed to radiate in an cell/sector); exclusion direction (e.g. a user terminal is not allowed to radiate in a certain direction); power limit (e.g. a maximum power limit that can be accepted by the second radio system); gradual power limit (e.g. the radio access points ensures that the transmit power close to the co-existing second radio system is low, while increasing when further away from the second radio system); indication of an alternative bandwidth where the interfering radio system is not active; reduction in the available bandwidth; a puncturing pattern for subcarriers to avoid interference; and/or location information, such as GPS.

According to an embodiment of the invention, the first radio system have two types of radio frequency spectrum, a dedicated radio spectrum and a shared radio spectrum. The dedicated radio spectrum is exclusively assigned to the first radio system so that there is no interference to or from the second system. The shared radio spectrum is in a shared use of the first and second radio systems. The primary operation of the first radio system may in the dedicated radio spectrum, and extra resources may be addressed in the shared radio spectrum, when required.

Any suitable mechanism or procedure may utilized for allocating resources from the shared spectrum to the first and second radio systems. Such mechanisms may include scanning of the radio spectrum, interference measurement in the radio spectrum, and/or resource negotiation with the second radio system, preferably by the radio access point or via an access gateway.

In an embodiment of the invention, the negotiation between the first and second system comprises local adjustment of the radio parameters via the radio access points. In another embodiment of the invention, operator level negotiations are carried out via an access gateway. These negotiations may relate to long-term or generic settings or sensitive settings of which the operator wants to remain in control (e.g. traffic information). In a further embodiment of the invention, both types of negotiations are used in the first radio system.

According to an embodiment of the invention, operation of a user terminal in the shared frequency spectrum is allowed only when a permission is obtained from the radio access point. The permission may be obtained by some active signaling. Alternatively, the obtaining of the permission may also mean that it is mandatory for a user terminal to wait until a message is received from the radio access point stating the availability of the band (e.g. beacon message or broadcast message). These mechanisms ensure that user terminals do not start to interfere, when the radio access point fails.

According to an embodiment of the invention, the beacon or control information regarding the shared radio spectrum is broadcasted in the dedicated radio spectrum of the first radio system so that the broadcast does not cause any interference to the second radio system. The control information may be transmitted on a control channel.

According to an embodiment of the invention, the beacon or control information is broadcast in the shared radio spectrum with appropriate radio separation with the second radio system. The appropriate radio separation may be provided by use of directional antennas for the broadcast. The control information may be transmitted on a control channel.

According to an embodiment of the invention, the shared radio spectrum is shared by at least one further radio system, in addition to the first and second radio system. According to an embodiment of the invention, the first radio system is a terrestrial radio system and the second radio system is a fixed satellite radio system, such as Fixed Satellite Services (FSS).

According to an embodiment of the invention, a radio access node of the first system is co-located with a satellite earth station of a fixed satellite system and arranged to broadcast the beacon or control information to all relevant cells of the first radio system in the neighborhood of the satellite earth station.

In an embodiment of the invention, relaying is used. When using relaying, Radio access points operating as relays may be placed between a user terminal and a radio access point operating as a base station, The relay may behave as a scaled-down base station and can help in extending the coverage range, providing extra diversity, etc. The relays enable to improve the spectrum sharing, e.g. by allowing adjusted transmission powers, or operation below rooftop that does not interfere with the other system (e.g. satellite or highly placed microwave links).

According to an embodiment of the invention, cell-specifically adjusted transmission rules are broadcasted in each cell. Radio access points operating as relays may be placed between a user terminal and a radio access point operating as a base station.

According to an embodiment of the invention, a plurality of radio access points are located in a ring configuration around the satellite earth station, each radio access point broadcasting the beacon or control information regarding the shared spectrum.

According to an embodiment of the invention, a radio access node of the first system is co-located with a satellite earth station of a fixed satellite system and arranged to transmit the beacon or control information to relay radio access points that, based on the information, create and broadcast locally adjusted transmission rules in their radio coverage areas.

According to an embodiment of the invention, a plurality of radio access points are located in a ring configuration around the satellite earth station, each radio access point broadcasting the beacon or control information regarding the shared spectrum.

According to an embodiment of the invention, the radio access point comprises a ring-shaped antenna array, preferably co-located with the satellite earth station, the ring-shaped antenna array broadcasting the beacon or control information regarding the shared spectrum.

According to an embodiment, a radio access node may be co-located and this co-located node may instruct surrounding relays to use adjusted radio parameters, (e.g. (gradually) lower transmit power, below rooftop operation only, etc.

According to an embodiment, a radio access node is co-located with the antenna of the second system, and surrounding cells may apply adjusted radio parameters.

According to an embodiment of the invention, the first radio system is a terrestrial radio system and the second radio system is a Fixed Service (FS) radio system, such as Fixed link, Fixed wireless access systems, Medium/high capacity fixed links, and transhorizon links.

According to an embodiment of the invention, the first radio system is a terrestrial radio system and the second radio system is a fixed microwave link. Again co-located antennae, and relays etc can be used.

Further embodiments of the invention include all combinations of the embodiments described above.

The present invention offers many potential advantages. The sharing of spectrum opens the way for obtaining new spectrum for future radio systems. Availability of more spectrum and larger bandwidths ensure higher data rates and possibly a better user experience through new services. Flexible spectrum usage allows operation of several different types of radio in the same frequency band in a flexible dynamic manner. Flexible spectrum usage will enable new ways of licensing spectrum, not only strictly licensed, or license-free or exempt, but also licensing with etiquette rules of how to share with other systems.

### BRIEF DESCRIPTION OF THE DRAWINGS

In the following the invention will be described in greater detail by means of example embodiments with reference to the attached drawings, in which

FIG. 1 is a functional block diagram of an example radio system according the invention;

FIG. 2 is a block diagram which illustrates an example of the configuration of a radio access point RAP; and

FIG. 3 illustrates an example of co-existence with an FSS system.

### EXAMPLE EMBODIMENTS OF THE INVENTION

Principles of the present invention can be applied to any radio system for sharing radio spectrum resources with one or more co-existing radio system. Some examples of suitable radio systems are illustrated below without intention to restrict the invention to these examples.

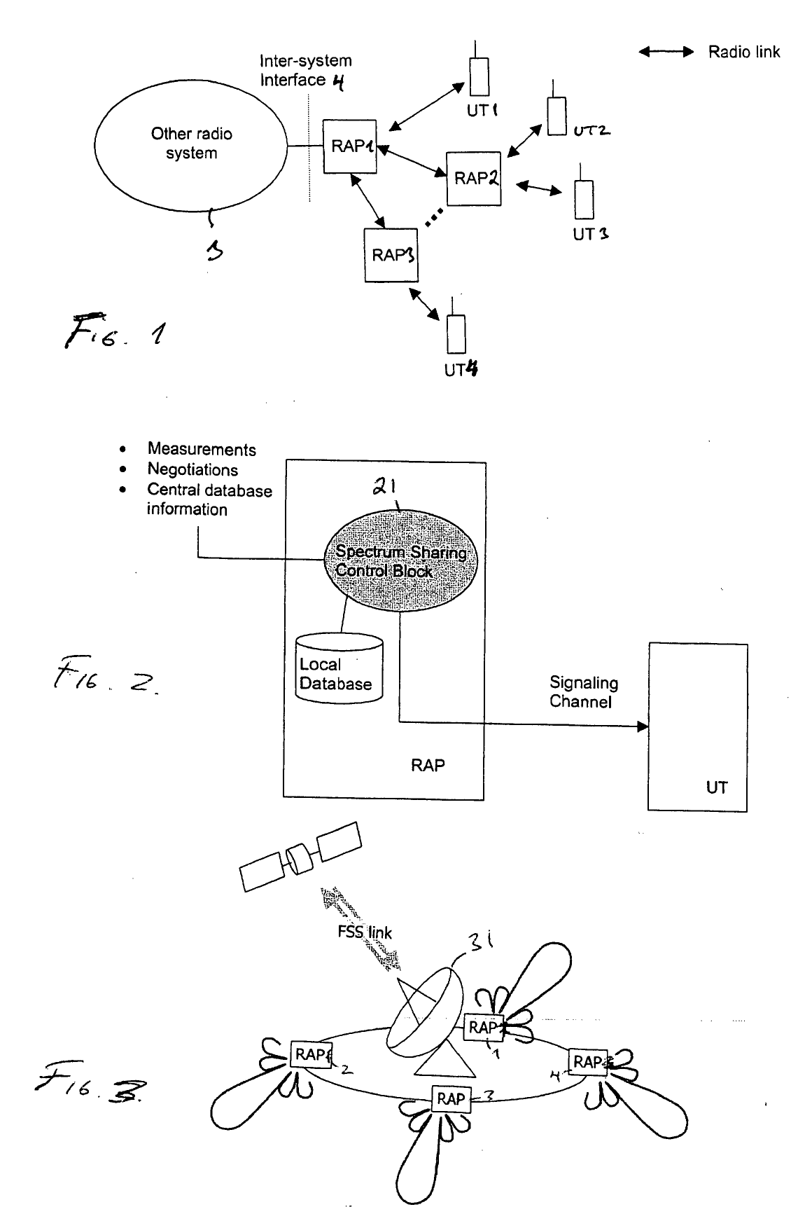

In FIG. 1, a functional block diagram of a radio system according an embodiment of the invention is shown. User terminals UT1, UT2, UT3, UT4 are connected to radio access points RAP1, RAP2, RAP3 in a radio infrastructure over radio links, i.e. over an air interface or a radio interface. In the example system shown FIG. 1, radio access points RAP1 is a base station transceiver. Radio access points RAP2, RAP3 are relay or repeater stations which relay transmissions from the base station RAP1 further to the respective user stations UT, and which relay transmissions from user stations UT to the base station RAP1. The radio access points RAP1-3 can be implemented with any base station technology or repeater technology suitable for the spesific radio system/technology wherein the invention is applied. For example, in a radio system according to the WINNER project the same radio interface may cover different domains. More information on the WINNER project can be obtained from Wireless World Research Forum (WWRF), http://wireless-world-research-forum.org. One or more of RAPs may be connected to another communication system 3, such as another radio system, through an appropriate inter-system interface 4 which allows direct negotiations with the other radio system 3. The radio system that includes the radio access points RAP1-RAP3 may preferably be connected to a core network, in which case an interface 4 to one or more other radio systems may be implemented through the core network

The present invention relates to obtaining new radio spectrum for (future) radio systems by means of spectrum sharing. The invention provides new efficient spectrum sharing mechanisms for operating in these new spectrum bands.

There are two processes: information retrieval about the other (second) system and signalling of the spectrum sharing information.

In the example embodiment shown in FIG. 1, it is assumed that the radio access points RAP1-3 and the user terminals UT1-4 share a common radio frequency spectrum with the other radio system 3 in at least one geographical location. The radio access points RAP1-3 (both base stations and relay stations) are provided with mechanisms for informing the user terminals UT1-4 to adjust their settings so that they can co-exist with the other radio system(s) 3. To that end, the radio access points RAP1-3 are provided with information about the other radio system(s) 3 and the corresponding limits the spectrum sharing impose on the operation of the user terminals UT1-4. The required information may be obtained from a distributed (local) database which is in associated with the RAP(s), or from a centralized database maintained elsewhere. The local database can be used by the respective RAP for spectrum sharing, e.g. signaling information can be retrieved from it, and decision can be based on the information that it contains. The database can contain the parameters that can be signaled, such as interference information, activity patterns, location information etc. According to an embodiment of the invention, combination of local and centralized databases is employed. Long-term information may be maintained in the centralized database, while the local database may contain the relevant parts of the centralized database and local short-term variations. If needed, the local database in the radio access point RAP can be updated with specific local information using for example scanning, various signal measurements, or a direct negotiation with the other radio system 3. The radio access point RAP may be able to measure in-band interference, for example, and combine the measurement result with a known activity pattern of the user terminal UT it is currently serving. As a result, a radio activity in the current frequency band can be determined for decision making.

However, it is not always possible to measure the interference received, and it is even more difficult (impossible) to measure the interference inflicted. Therefore, also direct negotiations with the other radio system(s) 3 via the interface 4 may be needed, in order to exchange information on used channels and the duration of use of channels in the shared frequency spectrum. In an embodiment of the invention, the negotiation with the other system 3 comprises local adjustment of the radio parameters via the radio access points RAP1-3. In another embodiment of the invention, operator level negotiations are carried out via an access gateway (not shown). These negotiations may relate to long-term or generic settings or sensitive settings of which the operator wants to remain in control (e.g. traffic information). In a further embodiment of the invention, both types of negotiations are used. It should be noted that the measurements and negotiations described above are only examples of suitable procedures for allocating resources from the shared spectrum. The allocation is not an essential feature of the invention. Further, in the case the relay radio access points RAP2-3 are mobile, they may inform the base station RAP1 of their location, which is required for location dependent adjustment of parameters. The local database may also contain the location of the different other RAPs. In the case of stationary relay access points RAP2-3, this is a static database. The other RAPs report their location upon initialisation, for example.

According to an embodiment of the invention, the radio access points RAP1-3 can use two types of radio frequency spectrum, a dedicated radio spectrum and a shared radio spectrum. The dedicated radio spectrum is exclusively assigned to use of the radio access points RAP1-3 first radio system so that there is no interference to or from the other radio system 3. The shared radio spectrum is in a shared use of the radio access points RAP1-3 and the other radio system 3. The primary operation of the user terminals UT1-4 may be in the dedicated radio spectrum, and extra resources may be addressed to the user terminals from the shared radio spectrum, when required.

According to the present invention, a non-interfering communication mechanism is provided between the radio access point RAP and the user terminal UT to signal information regarding the shared spectrum. More specifically, on the basis of the information provided to the radio access point RAP, the radio access point RAP creates and broadcasts beacon or control information to user terminals UT operating in the service area of the radio access point, to thereby enable the user terminals UT to adjust their operation so that they can co-exist with the other radio system 3. This control information may be transmitted on a control channel. According to an embodiment of the invention, the radio access points RAP1-3 broadcast the beacon or control information regarding the shared radio spectrum by means of the dedicated radio spectrum so that the broadcast does not cause any interference to the other radio system 3. This may introduce extra complexity since the user terminal UT has to listen to two frequency bands. However, in the future radio systems, such WINNER, this overhead will be small since radio part of user terminals should be capable of operating over a wide range of radio parameters including multi-band operation. In another embodiment, the beacon or control information is broadcast in the shared radio spectrum with appropriate radio separation with the other radio system 3. The appropriate radio separation may be provided by use of directional antennas for the broadcast. A preferred embodiment may be the concatenation of extra field to the beacon messages in the primary frequency band with information about availability of the shared band.

According to some embodiments of the invention, the broadcast beacon or control information may include one or more of following information elements: exclusion zone (e.g. a user terminal UT is not allowed to radiate in an cell/sector); exclusion direction (e.g. a user terminal UT is not allowed to radiate in a certain direction); power limit (e.g. a maximum power limit that can be accepted by the other radio system 3); gradual power limit (e.g. the radio access points ensures that the transmit power close to the co-existing other radio system 3 is low, while increasing when going further away from the other radio system 3); indication of an alternative bandwidth where the interfering radio system 3 is not active; reduction in the available bandwidth; a puncturing pattern for subcarriers to avoid interference; and/or location information, such as GPS. Location information (GPS) may assist the user terminal UT in determining direction to the radio access point RAP if the UT has a GPS of its own as well.

FIG. 2 is a block diagram which illustrates an example of the configuration of a radio access point RAP. The features of the invention would be implemented as a functional block 21 in a control unit of the radio access point RAP, while corresponding functional block operating as a client is implemented in a control unit of the user terminal UT. The functionality of the invention may preferably be implemented as an executable program code stored in memory of the radio access point and the user terminal, respectively, and run in their controller units, i.e. some type of computing devices. The measurement and negotiation functionality may typically be located in a RAP1 that is a base station, whereas both base station and relay station RAPs may implement the signalling channel.

The user terminals UT1-4 receive the beacon or control information from the radio access point RAP and adjust their transmission settings so that they can co-exist with the other radio system(s) 3.

As noted above, potential applications of the present invention include sharing and co-existence with Fixed Satellite Services (FSS), which is illustrated in FIG. 3, sharing and co-existence with microwave links, co-existence with a wireless LAN. Puncturing pattern can be exchanged to co-exist with WLAN. Puncturing relates to not using the subcarriers corresponding to the spectrum where the WLAN system is active.

FIG. 3 illustrates an example of co-existence with an FSS system. A ring of radio access points RAP1-4 (base stations or relays) are arranged to surround the satellite earth station 31 and to broadcast in a beacon message or a special control message over the control channel what the power restrictions are, i.e. transmission rules, so that there is no interference with the FSS system.

In a further example embodiment, a radio access point RAP1 operating as the base station transmits to the relay stations RAP2-4 a degrading power profile according to which the power is degraded less when the relays RAP2-4 are removed further away from the satellite earth station 31. In this manner the relays are used to limit the interference caused to the satellite station. Instead of relays also rings of ‘normal’ base stations could be used. Besides power it is also possible to prohibit the use of certain (parts of) bandwidths, when moving further away form the satellite station these bands can be taken into use again. There may be a difference in susceptibility to interference for example between different carrier frequencies used in the satellite system, or a difference in uplink and downlink bands (probably sharing with the uplink is not problematic). Different topologies for the ring of RAPs are possible:
a. One RAP may be co-located with the satellite antenna and broadcast spectrum information sharing to the whole cells
b. One RAP may be co-located and transmit to the whole cell, including relays that broadcast in their coverage area adjusted rules (hierarchical approach)
c. There may be a ring of RAPs around the antenna. This may also be implemented as a ring shaped antenna array
d. The adjusted transmission rules may also apply to multiple cells around the satellite antenna.

Also depending on the location of the station the scenario may be different. In a rural area the main objective may be to reduce the direct interference into the antenna (number of reflections is small). In an urban environment there are much more reflections, but here the use of the relays (operating below rooftop) can provide extra spatial diversity to reduce the interference conditions.

The above features discussed with reference to FIG. 3 can also be applied to enabling co-existence with other types of second radio systems, such as a microwave link.

It will be obvious to a person skilled in the art that, as the technology advances, the inventive concept can be implemented in various ways. The invention and its embodiments are not limited to the examples described above but may vary within the scope of the claims.

1. A method of using a radio frequency spectrum, comprising sharing a shared radio spectrum by a first radio system and a second radio system co-existing in at least one geographical location, said first radio system comprising radio access points providing user terminals of the first radio system with access to the first radio system at least in said shared radio spectrum,
providing at least one radio access point of the first radio system in said at least one geographical location with information on the co-existing second radio system and the constraints it causes to user terminals operating in the service area of the radio access point,
broadcasting, at said at least one radio access point, beacon or control information derived from said provided information to user terminals operating in the service area of said at least one radio access point, and
adapting operation of said user terminals in said shared radio spectrum according to said beacon or control information such that user terminals can operated co-existent with the second radio system.

2. A method according to claim 1, wherein the broadcast beacon or control information include one or more of following information elements: exclusion zone (e.g. a user terminal is not allowed to radiate in an cell/sector); exclusion direction (e.g. a user terminal is not allowed to radiate in a certain direction); power limit (e.g. a maximum power limit that can be accepted by the second radio system); gradual power limit (e.g. the radio access points ensures that the transmit power close to the co-existing second radio system is low, while increasing when further away from the second radio system); indication of an alternative bandwidth where the interfering radio system is not active; reduction in the available bandwidth; a puncturing pattern for subcarriers to avoid interference; and/or location information, such as GPS.

3. A method according to claim 1 or 2 wherein the first radio system have a dedicated radio spectrum exclusively assigned to the first radio system and a shared radio spectrum which is in a shared use of the first and second radio systems.

4. A method according to claim 3 wherein the primary operation of the first radio system is in the dedicated radio spectrum, and extra resources is addressed in the shared radio spectrum, when required.

5. A method according to any one of the preceding claims, comprising resources from the shared spectrum to the first and second radio systems, said allocation preferably including one or more of: scanning of the radio spectrum, interference measurement in the radio spectrum, and/or resource negotiation with the second radio system, preferably by the radio access point or via an access gateway.

6. A method according to claim 5, wherein the negotiation between the first and second system comprises local adjustment of the radio parameters via the radio access points, or operator level negotiations via an access gateway, or a combination thereof.

7. A method according to any one of the preceding claims, wherein operation of a user terminal in the shared frequency spectrum is allowed only when a permission is obtained from the serving radio access point

8. A method according to claim 7, wherein the permission is obtained by some active signaling or it is mandatory for a user terminal to wait until a message is received from the radio access point stating the availability of the shared spectrum.

9. A method according to any one of the preceding claims, wherein the beacon or control information regarding the shared radio spectrum is broadcasted in the dedicated radio spectrum of the first radio system, possibly on a control channel.

10. A method according to any one of the preceding claims, wherein the beacon or control information is broadcast in the shared radio spectrum with appropriate radio separation with the second radio system, possibly on a control channel.

11. A method according to claim 10, wherein a radio separation is provided by use of directional antennas for the broadcast.

12. A method according to any one of the preceding claims, wherein the shared radio spectrum is shared by at least one further radio system, in addition to the first and second radio system.

13. A method according to any one of the preceding claims, wherein the first radio system is a terrestrial radio system and the second radio system is a fixed satellite radio system, such as Fixed Satellite Services (FSS).

14. A method according to any one of the preceding claims, wherein a radio access node of the first system is co-located with a satellite earth station of a fixed satellite system and arranged to broadcast the beacon or control information to all relevant cells of the first radio system in the neighborhood of the satellite earth station.

15. A method according to any one of the preceding claims, wherein radio access points operating as relays may be placed between a user terminal and a radio access point operating as a base station.

16. A method according to any one of the preceding claims, wherein cell-specifically adjusted transmission rules are broadcasted in each cell.

17. A method according to any one of the preceding claims, wherein a plurality of radio access points are located in a ring configuration around the satellite earth station, each radio access point broadcasting the beacon or control information regarding the shared spectrum.

18. A method according to any one of the preceding claims, wherein a radio access node of the first system is co-located with a satellite earth station of a fixed satellite system and arranged to transmit the beacon or control information to relay radio access points that, based on the information, create and broadcast locally adjusted transmission rules in their radio coverage areas.

19. A method according to any one of the preceding claims, wherein a plurality of radio access points are located in a ring configuration around the satellite earth station, each radio access point broadcasting the beacon or control information regarding the shared spectrum.

20. A method according to any one of the preceding claims, wherein the radio access point comprises a ring-shaped antenna array, preferably co-located with the satellite earth station, the ring-shaped antenna array broadcasting the beacon or control information regarding the shared spectrum.

21. A method according to any one of the preceding claims, wherein a radio access node is co-located and this co-located node instructs surrounding relays to use adjusted radio parameters.

22. A method according to any one of the preceding claims, wherein a radio access node is co-located with the antenna of the second system, and surrounding cells may apply adjusted radio parameters.

23. A method according to any one of the preceding claims, wherein the first radio system is a terrestrial radio system and the second radio system is a Fixed Service (FS) radio system, such as Fixed link, Fixed wireless access systems, Medium/high capacity fixed links, and transhorizon links.

24. A method according to any one of the preceding claims, wherein the first radio system is a terrestrial radio system and the second radio system is a fixed microwave link.

25. A radio system, comprising
a shared radio spectrum shared with a second radio system co-existing in at least one geographical location,
radio access points providing user terminals with access to the radio system at least in said shared radio spectrum, and
at least one of said radio access points in said at least one geographical location being provided with information on the co-existing second radio system and the constraints it causes to user terminals operating in the service area of the radio access point;
said at least one radio access point being configured to broadcast beacon or control information derived from said provided information to user terminals operating in the service area of said at least one radio access point, to thereby enable said user terminals to adapt their operation in said shared radio spectrum according to said beacon or control information such that user terminals can operated co-existent with the second radio system.

26. A system according to claim 25, wherein radio access points operating as relays may be placed between a user terminal and a radio access point operating as a base station.

27. A system according to claim 25 or 26, wherein cell-specifically adjusted transmission rules are broadcasted in each cell.

28. A system according to any one of claims 25-27, wherein a plurality of radio access points are located in a ring configuration around the satellite earth station, each radio access point broadcasting the beacon or control information regarding the shared spectrum.

29. A system according to any one of claims 25-28, wherein the system have a dedicated radio spectrum exclusively assigned to the system and the shared radio spectrum is in a shared use of the system and the second radio system.

30. A system according to claims 29, wherein the primary operation of the system is in the dedicated radio spectrum, and extra resources is addressed in the shared radio spectrum, when required.

31. A radio access point for a first radio system, comprising
a shared radio spectrum shared with a second radio system co-existing in approximately same geographical location with the radio access point, to thereby provide user terminals with access to the first radio system at least in said shared radio spectrum,
a database which contains information on the co-existing second radio system and the constraints it causes to user terminals operating in the service area of the radio access point, and
a transmitter that broadcasts beacon or control information derived from said provided information to user terminals operating in the service area of said radio access point, to thereby enable said user terminals to adapt their operation in said shared radio spectrum according to said beacon or control information such that user terminals can operated co-existent with the second radio system.

32. A radio access point according to claim 31, wherein the radio access point comprises a ring-shaped antenna array, preferably co-located with the satellite earth station, the ring-shaped antenna array broadcasting the beacon or control information regarding the shared spectrum.

33. A radio access point according to claim 31 or 32, wherein said radio access node is co-located and instructs surrounding relays to use adjusted radio parameters.

34. A radio access point according to claim 31, 32 or 33, wherein said radio access node is co-located with the antenna of the second system, and surrounding cells may apply adjusted radio parameters.

35. A radio access point according to claim 31, 32, 33 or 34, wherein said radio access node is configured to operate as a relay station between a user terminal and a further radio access point operating as a base station

36. A relay radio access point for a first radio system, said relay radio access point being configured to operate as a relay station between a user terminal and a further radio access point operating as a base station, and comprising
a shared radio spectrum shared with a second radio system co-existing in approximately same geographical location with the relay radio access point, to thereby provide user terminals with access to the first radio system at least in said shared radio spectrum,
a receiver that receives from said further radio access point information on the co-existing second radio system and the constraints it causes to user terminals operating in the service area of the relay radio access point, and
a transmitter that broadcasts beacon or control information derived from said provided information to user terminals operating in the service area of said relay radio access point, to thereby enable said user terminals to adapt their operation in said shared radio spectrum according to said beacon or control information such that user terminals can operated co-existent with the second radio system.

37. A relay radio access point according to claim 36, wherein the relay radio access point is configured to, based on the information, create and broadcast locally adjusted transmission rules in its radio coverage area.

38. A user terminal, comprising
a transceiver which employs a shared radio spectrum shared with a first radio, system and a second radio system co-existing in approximately same geographical location with a serving radio access point of the first radio system, to access to the first radio system at least in said shared radio spectrum, and
a control unit which is configured to, based on beacon or control information broadcasted by the radio access point of the first radio system, adapting operation of said user terminal in said shared radio spectrum according to said beacon or control information such that the user terminal can operate co-existent with the second radio system, said beacon or control information containing information on the use of the shared radio spectrum.

39. A user terminal according to claim 38, wherein the broadcast beacon or control information include one or more of following information elements: exclusion zone (e.g. a user terminal is not allowed to radiate in an cell/sector); exclusion direction (e.g. a user terminal is not allowed to radiate in a certain direction); power limit (e.g. a maximum power limit that can be accepted by the second radio system); gradual power limit (e.g. the radio access points ensures that the transmit power close to the co-existing second radio system is low, while increasing when further away from the second radio system); indication of an alternative bandwidth where the interfering radio system is not active; reduction in the available bandwidth; a puncturing pattern for subcarriers to avoid interference; and/or location information, such as GPS.

40. A user terminal according to claim 38 or 39, wherein the broadcast contains locally adjusted transmission rules.

41. A user terminal according to any one of claims 38-40, wherein the first radio system have a dedicated radio spectrum exclusively assigned to the first radio system and a shared radio spectrum which is in a shared use of the first and second radio systems, and wherein the control unit allows operation of a user terminal in the shared frequency spectrum only when a permission is obtained from the serving radio access point.

42. A user terminal according to any one of claims 38-41, wherein the primary operation of the first radio system is in the dedicated radio spectrum, and extra resources is addressed in the shared radio spectrum, when required, and wherein the control unit allows operation of a user terminal in the shared frequency spectrum only when a permission is obtained from the serving radio access point.

43. A user terminal according to claim 41 or 42, wherein the permission is obtained by some active signaling or it is mandatory for a user terminal to wait until a message is received from the radio access point stating the availability of the shared spectrum.
